(19) United States
(12) Patent Application Publication
(10) Pub. No.: US 2022/0369615 A1
(43) Pub. Date: Nov. 24, 2022

(54) Weeding Tool

(71) Applicant: Jerry Bryant O'Neil, Columbia Falls, MT (US)

(72) Inventor: Jerry Bryant O'Neil, Columbia Falls, MT (US)

(21) Appl. No.: 17/326,345

(22) Filed: May 21, 2021

(51) Int. Cl. A01M 21/02

(52) U.S. Cl. CPC A01M 21/02

(57) ABSTRACT

This weeding tool is designed to make removing weeds with centralized, non-distributed root systems easy. The tip is designed for easy insertion into even fairly compact soil conditions that are difficult for many other tools of a similar nature. The unique features of this tool versus other tools of a similar nature is the tip length may be changed in a manner that no other tool of a similar nature has, to optimize the tool for the weeding conditions, and the tip itself can be changed out for other tip designs, even for non-weeding purposes, such as a shovel or a pick.

### CROSS-REFERENCE TO RELATED APPLICATIONS

Not Applicable

### BACKGROUND OF THE INVENTION

Since humanity began tilling the earth—and perhaps even earlier—weeds have been objects for elimination. The first helpful tool for the task was probably a simple digging stick. Since then ingenuity and technology have brought about many alternatives for the job. They can be broken into rough categories:
Hand tools of various designs, for use when the operator bends over, crouches, or kneels on the ground. For instance, U.S. Pat. No. 1,398,850A.
Shovels, that dig up weeds. This approach often results in a hole that needs to be refilled. Long roots can also be cut instead of removed, allowing the weeds to quickly grow back. For example, US20070284123A1.
Hoes that are narrower than shovels don't create such big holes, but the dirt also needs to be pushed back into the affected area. Hoes also have a tendency to cut the weeds rather than take them out in one piece. Another detriment of hoes is they usually cannot be easily inserted into very compacted soil using the operator's body weight, due to their design. For one example, see U.S. Pat. No. 1,889,286A.
‘Digging forks,’ which are similar to shovels, but usually have four or more tines instead of a shovel that loosen the dirt to ease the removal of weeds. An example of this design is in GB189521811A.
Tools commonly known as ‘broadforks,’ that have multiple tines attached to a bar that are pushed into the earth by foot, and rotated through the soil by leveraging the handle to loosen the dirt and make weed removal easier. An example of this design is FR1378114A. These tools are more appropriate for large-scale soil loosening rather than individual weed extraction.
Tools that dig into the earth and entangle the weed when rotating the tool, allowing the user to pull the tool out of the earth with the weed attached. For example, see U.S. Pat. Nos. 2,680,643A and 2,860,001A. (Some bit designs can be used with electric drills, to speed up the operation.) Cons to this method are the tool often cuts the weed instead of entangling it, leaving the weed to quickly grow back. Also, removing the roots from the entangling contraption can be time consuming.
Tools that dig around the root, to ease weed removal. For example, U.S. Pat. No. 8,714,277B2.
Above-surface tools that clamp onto the stem of the weed that use leverage or clamp action to pull/pry the weed out of the earth. Examples of this approach are U.S. Pat. No. 6,938,937B1, U.S. Pat. No. 5,535,833A, and FR2647625A1. The shortcoming of this method is the root often isn't entirely removed, allowing the weed to quickly grow back.
Coring tools, that are inserted into the earth around the weed, clamp onto the earthen core, and remove it and the captured weed when the tool is removed. For example, U.S. Pat. No. 2,035,967A.
Coring tools that don't clamp onto the core, but pinch it in a manner to try ensuring it gets pulled out, such as U.S. Pat. No. 2,686,690A.
Tools that both dig into the earth surrounding the weed, and clamp the surrounding earth and the weed root. For examples, US20060289178A1 and U.S. Pat. No. 4,473,248A.
Plowing devices, such as CN206226940U, which allow the operator to continuously plow a furrow into the earth and loosen weeds.
Rototillers, and other electrical or engine-powered devices (i.e., tractor driven) which won't be touched upon here as they are of a different nature than the device of this patent application.
Compressed air tools such as an “Air Spade” can blow the weed and the surrounding dirt out of the earth.
Picking/digging tools that allow the operator to work the root of the weed loose, for easy removal after picking/digging occurs. For examples, U.S. Pat. Nos. 5,848,653A and 1,857,500A.

This weeding tool is of the last variety: a pick-type tool. It is useful for easing the removal of weeds with taproots which aren't spread out.

The following summarizes the differences between this tool and prior art.

The closest prior art in terms of design intent is US2002029892A1. It does not have an adjustable tip length, nor is the tip easily replaceable.

U.S. Pat. No. 1,757,925A is a post spade and earth drill that has an adjustable length tip, as well as a replaceable tip, but the design of both differs from the present invention, being more complex to manufacture than the present design. The intent of U.S. Pat. No. 1,757,925A—being used for digging holes—also differs from that of the present invention, which is to dislodge the weed root without requiring more than a tamping operation to re-flatten the disturbed soil.

A different multi-attachment design for tools of this nature is given in U.S. Pat. No. 6,047,651A. It differs from this invention in the fact that the attachments must have a corresponding threaded portion in the tip, whereas those for this design only require a slightly smaller sized shaft to insert into a collet device.

CA746380A is an adjustable fulcrum for a lever that is far more complicated than the foot peg fulcrums in this invention. Also, in the current design, the lever effect length easily adjusts rather than the fulcrum position as in CA746380A.

Prior art most similar to the current design, but missing the adjustable tip and easily replaceable tip include: U.S. Pat. No. 4,715,634A, US20030227185A1, US20160120091A1, U.S. Pat. Nos. 1,323,630A, 385,324A, 5,109,930A, and CN204689593U.

US20040065452A1 and U.S. Pat. No. 4,815,778A have an adjustable tip length mechanism which differs in operation from the present invention. They do not have easily replaceable tips.

Prior art of similar design or intention worth mentioning, but more dissimilar than the previous items, include: U.S. Pat. No. 4,815,778A, US20110203815A1, U.S. Pat. Nos. 5,257,666A, 5,234,241A, 4,281,866A, D657,639S, 4,618,003A, 3,865,348A, 3,680,641A, 1,998,314A, US20130062081A1, U.S. Pat. Nos. 2,716,538A, 1,131,714A, US20080105444A1, US20090273198A1, U.S. Pat. No. 5,060,997A, 7,104,576B1, 6,257,346B1, 5,469,923A, 1,528,157A, 3,847,226A, WO03037062A1, U.S. Pat. Nos. 6,959,768B1, 2,791,879A, 5,234,241A, GB2352607A, US20060037301A1, U.S. Pat. No. 3,838,739A, US20060185863A1, U.S. Pat. Nos. 5,467,830A, 2,378,459A, US20060090911A1, U.S. Pat. Nos. 3,149,873A, 799,359A, JPH0714802U, US20010045293A1, U.S. Pat. No. 5,609,325A, CN207854423U, U.S. Pat. No. 933,227A, US20030056961A1, U.S. Pat. Nos. 1,107,705A, 3,976,282A, and 212,953A.

### BRIEF SUMMARY OF THE INVENTION

This invention is a digging tool designed to be easily inserted into the earth close to the weed, between the weed and the operator. The invention has foot pegs that become a fulcrum when they are pushed into contact with the earth. Once they become a fulcrum, the handle/shaft of the tool is pulled toward the operator and then pushed towards the ground, which breaks up the dirt around the root and forces the weed up. The weed can then easily be removed, and after removing the invention the dislodged earth can be easily tamped back down. The tip of the invention can be lengthened or shortened, to optimize the insertion depth for the weeding conditions. The tip can also be changed out for a tip of another design or purpose (i.e., a shovel instead of a weeding tool).

### BRIEF DESCRIPTION OF THE SEVERAL VIEWS OF THE DRAWING

FIG. 1 is an orthogonal view of the invention from the front, as an operator would face it to begin a weeding operation.

FIG. 2 is the same view as FIG. 1, but with callouts to the individual components matching the Detailed Description Of The Invention section.

FIG. 3 is a right projection view of FIG. 2.

FIG. 4 is a bottom projection view of FIG. 2.

FIG. 5 is an abbreviated view of the main shaft (1), showing the axial cut in the threaded end that allows that end to clamp onto the tip (2) when the nut is tightened.

FIG. 6 is a cutaway view A-A, called out in FIG. 2, showing the nut and the threads. The dashed lines extending beyond the parts is an imaginary extension of the thread taper, to indicate that as the nut is tightened and moves upward in the figure, the shaft end gets pinched radially, and clamps on to the tip (2).

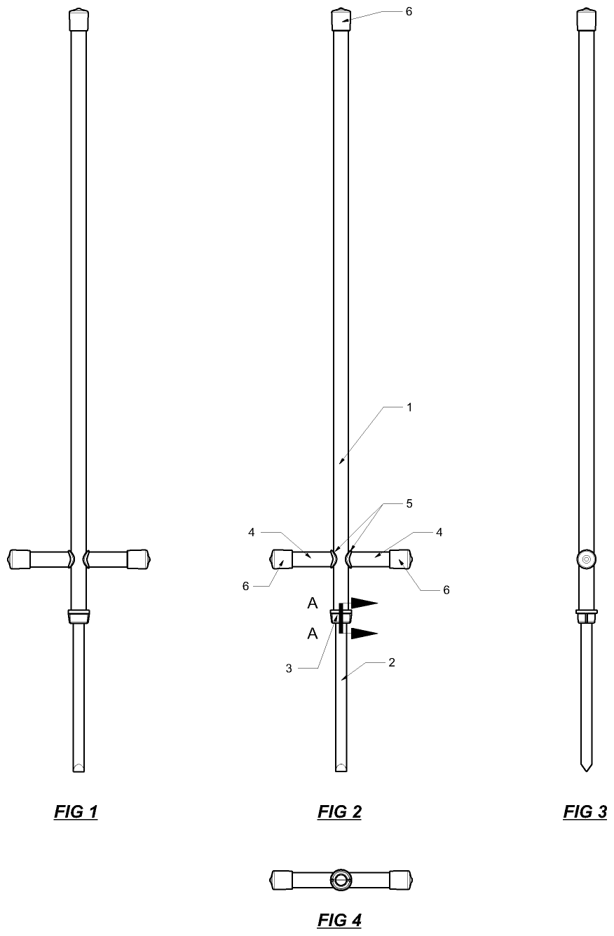

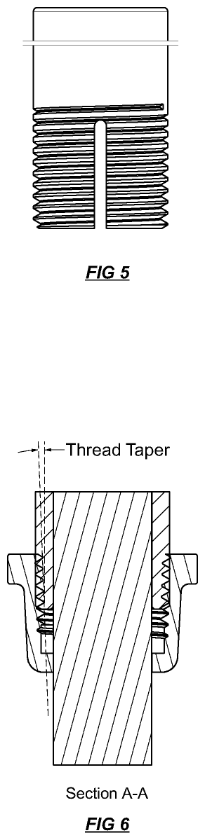

### DETAILED DESCRIPTION OF THE INVENTION

This weeding tool is made up of a solid metal round rod tip (2) with one end tapered, to allow it to be easily inserted into the ground. The other end of the rod tip (2) is inserted into a cylindrical metal shaft (1) which has an inside diameter slightly larger than the outside diameter of the round rod tip (2). The end of the shaft (1) which the rod tip (2) inserts into has a narrow slit or narrow slits cut axially along the shaft (1) for approximately the outside diameter of the shaft. That end also has a tapered outside thread cut into it, tapered so the thread at the end of the shaft cuts more deeply into the shaft than where the thread terminates on the shaft. A nut (3) is tightened onto the end of the shaft (1). The nut (3) has an inside tapered thread, tapered so that the diameter of the end which first mates with the shaft (1) is bigger than the opposite end of the nut. In conjunction with the slit or slits, that end of the shaft (1) becomes a collet-like device. Tightening the nut (3) squeezes the collet-type end of the shaft (1), capturing the rod tip (2). The length of rod tip insertion into the shaft can be adjusted by loosening the nut (3), moving the rod tip (2) into or out of the shaft (1) until the length is appropriate for the work being done, and then re-tightening the nut (3).

Near the threaded end of the shaft (1) two short cylindrical rod foot pegs (4) are attached (5), perpendicularly and at opposite sides to each other, so the operator can easily apply their body weight to the weeding tool and insert the tip (2) into the soil.

Caps (6) may be placed on the end of the shaft (1) and the foot pegs (4) to keep dirt and other particles out from any cavities in the weeding tool.

To use the weeding tool, the operator optionally adjusts the rod tip (2) to a desired length. After tightening the nut (3) to finish the operation, they then place the rod tip (2) between themselves and the weed, in proximity to the weed. The operator presses the tool into the ground using their body weight to press their foot down on one of the foot pegs (4). Once the foot pegs (4) are pressed to the ground, the operator removes their foot and pulls the top of the shaft (1) towards them, using it as a lever to move the tip (2) in the opposite direction through the ground, dislodging the dirt around the weed and making the weed easy to pull from the ground.

1. A Weeding Tool comprising: a) a cylindrical main shaft with a tapered external thread cut onto one end. The main shaft has one or more axial slots cut onto the threaded end, extending from the end of the main shaft to approximately a length equal to the outside diameter of the main shaft away from that end; b) a tip which is a round bar with an outside diameter sized for minimal clearance with the inside diameter of the main shaft. One end of the tip is inserted into the main shaft, the other end protrudes from the main shaft and has a tapered end for inserting into the soil to loosen the weed; c) two foot pressure bars affixed perpendicularly to the main shaft, at opposition to each other, proximally to the end of the main shaft into which the tip is inserted; d) a nut with an inside tapered thread matching the outside tapered thread on the end of the main shaft, which is tightened onto the threaded end of the main shaft, pinching the end of the main shaft, capturing and locking the tip onto the main shaft; and e) optional caps placed on any shaft orifices to keep particulate matter out of the Weeding Tool.

2. The Weeding Tool of claim 1, in which the tip length can be changed to the weeding conditions by loosening the nut, moving the tip further into or out of the main shaft, and then re-tightening the nut.

3. The Weeding Tool of claim 1, in which the tip can be removed and replaced by a tip of another design, for a similar or different purpose (such as a shovel).
